(19) United States
(12) Patent Application Publication
(10) Pub. No.: US 2023/0395806 A1
(43) Pub. Date: Dec. 7, 2023

(54) ALL-SOLID-STATE BATTERY OPERABLE AT ROOM TEMPERATURE AND METHOD OF MANUFACTURING SAME

(71) Applicants: Hyundai Motor Company, Seoul (KR); Kia Corporation, Seoul (KR)

(72) Inventors: Jae Min LIM, Suwon (KR); Hong Suk Choi, Hwaseong (KR); Seon Hwa Kim, Cheongju (KR); Hee Soo Kang, Seoul (KR); Young Jin Nam, Suwon (KR); Sang Wan Kim, Anyang (KR)

(21) Appl. No.: 18/080,437

(22) Filed: Dec. 13, 2022

(30) Foreign Application Priority Data
Jun. 2, 2022 (KR) 10-2022-0067307

(51) Int. Cl. H01M 4/62; H01M 4/04

(52) U.S. Cl. CPC H01M 4/628; H01M 2004/021; H01M 4/0461

(57) ABSTRACT

Disclosed herein is an all-solid-state battery operable at room temperature and a method of manufacturing the same. The all-solid-state battery includes a negative electrode current collector, an intermediate layer positioned on the negative electrode current collector and including include a carbon component and a lithium alloy, a solid electrolyte layer positioned on the intermediate layer, a positive electrode active material layer positioned on the solid electrolyte layer and including a positive electrode active material that stores and releases lithium ions, and a positive electrode current collector positioned on the positive electrode active material layer.

### CROSS REFERENCE TO RELATED APPLICATION

The present application claims priority to Korean Patent Application No. 10-2022-0067307, filed Jun. 2, 2022, the entire contents of which is incorporated herein for all purposes by this reference.

### TECHNICAL FIELD

The present disclosure relates to an all-solid-state battery operable at room temperature and a method of manufacturing the same.

### BACKGROUND

An all-solid-state battery is a three-layer laminate composed of a positive electrode active material layer bonded to a positive electrode current collector, a negative electrode active material layer bonded to a negative electrode current collector, and a solid electrolyte layer disposed between the positive electrode active material layer and the negative electrode active material layer.

In the related art, the negative electrode active material layer includes a solid electrolyte for movement of lithium ions as well as a negative electrode active material, such as graphite, and the like. Solid electrolytes have a higher specific gravity than liquid electrolytes. For this reason, all-solid-state batteries using a solid electrolyte have a lower energy density than lithium-ion batteries using a liquid electrolyte.

To overcome such a problem and increase the energy density of all-solid-state batteries, research on the use of lithium metal as a negative electrode material has been conducted. However, for commercialization of all-solid-state batteries, technology issues such as interfacial bonding and lithium-dendrite growth and industrial issues such as price and large-scale optimization may need to be solved.

Recently, research on a storage-type anode-less all-solid-state battery has been in progress. The anode-less all-solid-state battery does not have an anode, and lithium ions (Li⁺) are directly deposited as lithium metal on an anode current collector. However, this anode-less all-solid-state battery has a problem in that lithium deposition is not uniform and thus dead lithium is formed.

### SUMMARY

In preferred aspects, provided are an anode-less all-solid-state battery- capable of being charged and discharged at room temperature, and a method of manufacturing the same battery.

A term “all-solid-state battery” as used herein refers to a rechargeable secondary battery that includes an electrolyte in a solid state and other electrolytic components for transferring ions between the electrodes of the battery.

The term “anodeless-type all-solid-state battery” as used herein refers to an all-solid state battery that lacks a compatible, parallel and/or structural similar looking component of the counter electrode of a cathode, i.e. anode. Rather the anodeless-type all-solid battery may include a functional component that similarly or equivalently serves as a conventional anode. In certain embodiments, the anode current collector layer may be used as the counter electrode of the cathode in the anodeless-type all-solid battery without including an anode layer (e g., lacking anode active material layer or lithium layer) and form non-matching or non-symmetric structure to the cathode.

Objectives of the present disclosure are not limited to the objectives mentioned above.

The above and other objectives of the present disclosure will become more apparent from the following description, and will be realized by the means of the appended claims, and combinations thereof.

In an aspect, provided is a all-solid-state battery including a negative electrode current collector, an intermediate layer positioned on the negative electrode current collector, a solid electrolyte layer positioned on the intermediate layer, a positive electrode active material layer positioned on the solid electrolyte layer and including a positive electrode active material that stores and releases lithium ions, and a positive electrode current collector positioned on the positive electrode active material layer. The intermediate layer may include a carbon component and a lithium alloy.

The lithium alloy may include lithium and one or more metal components selected from the group consisting of Au, Pt, Pd, Si, Ag, Al, Bi, Sn, and Zn.

The lithium alloy may have a particle size (D50) of about 50 nm or less.

A term “D50” as used herein refers to a median particle diameter or median particle size.

The intermediate layer may include the lithium alloy in a discharged state.

The intermediate layer may include an amount of about 30% to 85% by weight of the carbon component and an amount of about 15% to 70% by weight of the lithium alloy based on the total weight of the intermediate layer.

The intermediate layer may include a plurality of layers each of which includes the carbon component and the lithium alloy.

An interlayer barrier may be disposed on the each of the plurality layers of the intermediate layer for allowing lithium ions to pass through but not allowing the lithium alloy to pass through.

The intermediate layer may have a thickness in a range of about 3μm to 30 μm.

The all-solid-state battery may operate at a temperature of about 40° C. or below.

In an aspect, provided is a method of manufacturing an all-solid-state battery and the method includes steps of: preparing a laminate and charging the laminate. The laminate includes a negative electrode current collector, a precursor layer positioned on the negative electrode current collector, a solid electrolyte layer positioned on the precursor layer, a positive electrode active material layer positioned on the solid electrolyte layer, and a positive electrode current collector positioned on the positive electrode active material layer. The precursor layer includes a carbon component and a metal which can form an alloy with lithium. The positive electrode active material layer includes a positive electrode active material which stores and releases lithium ions. When the laminate is charged, an alloying reaction may occur between the metal and lithium, thereby forming an intermediate layer including a lithium alloy and the carbon component.

The metal may include one or more selected from the group consisting of Au, Pt, Pd, Si, Ag, Al, Bi, Sn, and Zn.

The laminate may be charged at a temperature in a range of about 45° C. to 60° C.

The laminate may be charged at a voltage level of about 2.5 V to 4.25 V at a charging rate of about 0.1 C to 1 C, to a state of charge (SoC) level of about 10% or less to cause an alloying reaction between the metal and lithium.

The lithium alloy may have a particle size (D50) of about 50 nm or less.

The precursor layer may include a plurality of layers each including the carbon component and the metal so that the intermediate layer may include a plurality of layers each including the carbon component and the lithium alloy.

An interlayer barrier is disposed on the each of the plurality layer of the intermediate layer for allowing lithium ions to pass through but not allowing the lithium alloy to pass through.

The intermediate layer may include the lithium alloy in a discharged state of the all-solid-state battery.

The intermediate layer may include an amount of about 30% to 85% by weight of the carbon component and an amount of about 15% to 70% by weight of the lithium alloy, based on the total weight of the intermediate layer.

The intermediate layer may have a thickness in a range of about 3 μm to 30 μm.

The battery has an operating temperature of about 40° C. or less.

Also provided is a vehicle including the all-solid-state battery as described herein.

According to various exemplary embodiment of the present disclosure, an anode-less all-solid-state battery capable of being charged and discharged at room temperature can be provided.

Other aspects of the invention are disclosed infra.

### BRIEF DESCRIPTION OF THE DRAWINGS

FIG. 1 shows an exemplary all-solid-state battery according to an exemplary embodiment of the present disclosure;

FIG. 2 shows an exemplary intermediate layer according to an exemplary embodiment of the present disclosure;

FIG. 3 shows an exemplary intermediate layer according to an exemplary embodiment of the present disclosure;

FIG. 4 shows a reference diagram illustrating a method of manufacturing an all-solid-state battery according to an exemplary embodiment of the present disclosure;

FIG. 5 shows results of analysis performed with a scanning electron microscope (SEM) and an energy dispersive X-ray spectrometer (EDS), for a cross section of an all-solid-state battery according to Example 1;

FIG. 6 shows SEM and EDS analysis results for a cross-section of an all-solid-state battery according to Example 2;

FIG. 7A shows a result of analysis performed with a cross-section polisher-scanning electron microscope (CP-SEM), for a cross section of an all-solid-state battery according to Comparative Example, the analysis being performed after charging the all-solid-state battery;

FIG. 7B shows a CP-SEM analysis result for a cross-section of an all-solid-state battery according to Example 1, the analysis being performed after charging the all-solid-state battery;

FIG. 7C shows a CP-SEM analysis result for a cross-section of an all-solid-state battery according to Example 2, the analysis being performed after charging the all-solid-state battery;

FIG. 8 shows the results of measuring the capacity of each of the all-solid-state batteries according to Example 1, Example 2, and Comparative Example; and

FIG. 9 shows the results of evaluating the durability of each of the all-solid-state batteries according to Example 1, Example 2, and Comparative Example.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

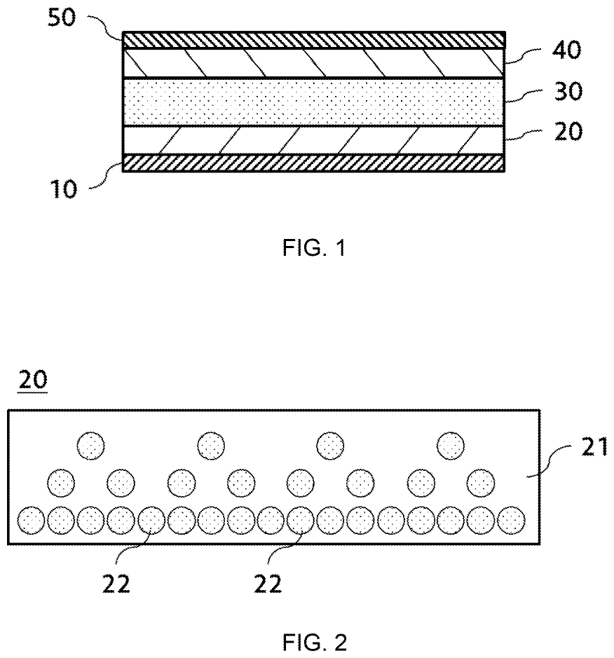

FIG. 1 shows an all-solid-state battery according to an exemplary embodiment of the present disclosure. As shown in FIG. 1, the all-solid-state battery may include a negative electrode current collector an intermediate layer 20 positioned on the negative electrode current collector 10, a solid electrolyte layer 30 positioned on the intermediate layer 20, a positive electrode active material layer 40 positioned on the solid electrolyte layer 30, and a positive electrode current collector 50 positioned on the positive electrode active material layer 40.

FIG. 1 shows a discharged state of the all-solid-state battery. When the all-solid-state battery is charged, lithium ions released from the positive electrode active material layer 40 move to the intermediate layer 20 through the solid electrolyte layer 30. Then, the lithium ions are deposited and stored between the negative electrode current collector 10 and the intermediate layer 20 and/or in the intermediate layer 20 to form a lithium metal layer (not illustrated).

The negative electrode current collector 10 may be an electrically conductive plate-shaped substrate. Particularly, the negative electrode current collector 10 may have a form of a sheet, a thin film, or foil.

The negative electrode current collector 10 may include a material that does not react with lithium. Particularly, the negative electrode current collector 10 may include Ni, Cu, stainless steel (SUS), or combinations thereof.

It has been reported that, in the related art, when a coating layer including a carbon component, metal component and the like is formed on a negative electrode current collector, lithium metal can be uniformly formed on the negative electrode current collector. For example, at the early stage of charging and discharging, a lithiation reaction between lithium ions and metal occurs to form an alloy, and the alloy facilitates conduction of lithium ions and uniform precipitation of lithium ions. However, since such a lithiation reaction occurs only at temperatures of about 45° C. or greater, such an anode-less all-solid-battery will not operate normally at room temperature of about 25° C.

FIG. 2 shows an intermediate layer 20 according to an exemplary embodiment of the present disclosure. To solve the above problem occurring in the related art, the present disclosure provides a structure in which an intermediate layer 20 including a carbon component 21 and a lithium alloy 22 may be disposed on the negative electrode current collector 10.

The lithium alloy 22 may provide a passageway for lithium ions in the intermediate layer 20. In particular, the intermediate layer 20 may include the lithium alloy 22 in a discharged state. Unlike an existing anode-less all-solid-state battery, a lithiation reaction between lithium ions and metal is not required to form the lithium alloy 22 at the early stage of charging. Accordingly, when the all-solid-state battery is charged at room temperature, lithium ions can easily move through the lithium alloy 22 in the intermediate layer 20. Here, the term “discharged state” may refer to a state in which the remaining charge of the all-solid-state battery is 15% or less, or 10% or less, or 5% or less, or 0% with respect to the total capacity of the all-solid-state battery.

The lithium alloy 22 may include lithium and one or more metals selected from the group consisting of Au, Pt, Pd, Si, Ag, Al, Bi, Sn, and Zn. The ratio of the lithium and the metal is not particularly limited. For example, the lithium alloy may be an alloyed product of the lithium and the metal in a weight ratio of about 0.1 to 99.9:99.9 to 0.1.

The lithium alloy 22 may have a particle size (D50) of about 50 nm or less. The particle size (D50) is not particularly limited. For example, the particle size (D50) may be about 5 nm or greater, or about 10 nm or greater, or about 20 nm or greater.

The carbon component 21 may include amorphous carbon. The amorphous carbon is not particularly limited. Examples of the amorphous carbon may suitably include furnace black, acetylene black, Ketjen black, and the like.

The intermediate layer 20 may include an amount of about 30% to 85% by weight of the carbon component 21 and an amount of about 15% to 70% by weight of the lithium alloy 22, based on the total weight of the intermediate layer 20. When the content of the lithium alloy 22 is less than about 15% by weight, lithium ions in the intermediate layer 20 may not easily move. When the content of the lithium alloy 22 is greater than 70% by weight, the dispersibility may be deteriorated.

On the other hand, even though the specific mechanism has not been characterized, the lithium alloy does not appear to be evenly distributed in the intermediate layer 20 and move toward the negative electrode current collector 10 as shown in FIG. 2 during the formation thereof. Accordingly, the intermediate layer 20 includes a lithium alloy-rich region and a lithium alloy-poor region arranged in a direction of the thickness of the intermediate layer 20. As a result, lithium ions cannot easily move in the lithium alloy-poor region of the intermediate layer 20.

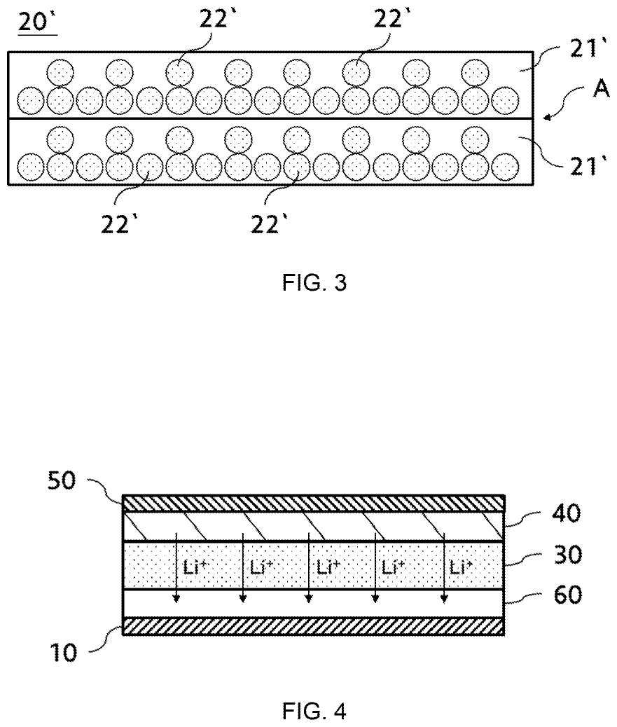

FIG. 3 shows an intermediate layer 20′ according to an exemplary embodiment of the present disclosure. As shown in FIG. 3, the intermediate layer 20′ may include a plurality of layers each including a carbon component 21′ and a lithium alloy 22′. Although FIG. 3 illustrates the intermediate layer 20′ composed of two layers, the present disclosure is not limited thereto. The number of layers constituting the intermediate layer may be appropriately adjusted depending on desired characteristics and the specification of an all-solid-state battery.

Each of the plurality of layers of the intermediate layer 20′ may be bordered by an interlayer barrier A. In other words, the interlayer barrier A may be disposed on the each of the plurality of layers of the intermediate layer 20′. The interlayer barrier A refers to an interface that physically separates the layers from each other but is not a conceptual component. Accordingly, even though the lithium alloy 22′ included in each layer exhibits a behavior of moving towards the negative electrode current collector during formation of the intermediate layer 20′, the lithium alloy 22′ is not allowed to pass through the interlayer barrier A. For this reason, there is no significant difference in the content distribution of the lithium alloy 22′ along the direction of the thickness of the intermediate layer 20′. Therefore, lithium ions can easily move throughout the intermediate layer 20′ according to an exemplary embodiment of the present disclosure. In addition, even though a lithium alloy-poor region occurs in the intermediate layer 20′ due to the movement of the lithium alloy 22′ toward the negative electrode current collector 10, since the region has a short length, the overall lithium ion conductivity is not significantly affected.

On the other hand, the lithium alloy 22′ may not be allowed to pass through the interlayer barrier A and is thus distributed around the interlayer barrier A. Therefore, lithium ions can pass through the interlayer barrier A.

The intermediate layer 20 may have a thickness in a range of about 3 μm to 30 μm. When the thickness of the intermediate layer 20 is less than about 3 μm, it may be difficult to achieve uniform precipitation and storage of lithium ions. When the thickness of the intermediate layer 20 is greater than about 30 μm, lithium ions cannot easily move, and the energy density of the all-solid-state battery may be lowered.

As described above, the all-solid-state battery according to an exemplary embodiment of the present disclosure is not required to be charged and discharged at high temperatures because the lithium alloy 22 capable of conducting lithium ions is present in the intermediate layer 20 in a discharged state. That is to say, the all-solid-state battery can operate at a temperature of about 40° C. or less. The lower limit of the operating temperature range is not particularly limited, and the lower limit may be the same or similar to the lower limit of a typical battery operating temperature range typically used in the art to which the present disclosure pertains.

The solid electrolyte layer 30 may allow conduction of lithium ions from the positive electrode active material layer 40 to the intermediate layer 20.

The solid electrolyte layer 30 may include a solid electrolyte having a lithium ion conductivity.

The solid electrolyte may include one or more selected from the group consisting of an oxide-based solid electrolyte, a sulfide-based solid electrolyte, and a polymer electrolyte. However, preferably, a sulfide-based solid electrolyte having a high lithium ion conductivity is used. The sulfide-based solid electrolyte is not particularly limited. Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₘ (where m and n is each independently a positive integer, and Z is one of Ge, Zn and Ga), Li₂S—GeS₂, Li₂S—SiS₂—Li₃PO₄, Li₂S—SiS₂—LiₓMO_{y} (where x and y is each independently a positive integer, and M is one of P, Si, Ge, B, Al, Ga, and In), Li₁₀GeP₂S₁₂, and the like.

Examples of the oxide-based solid electrolyte may include perovskite-type LLTO (Li₃ₓLa_{2/3}-ₓTiO₃), phosphate-based NASICON-type LATP (Li₁₊ₓAlₓTi₂₋ₓ(PO₄)₃), and the like.

Examples of the polymer electrolyte may include a gel polymer electrolyte, a solid polymer electrolyte, and the like.

The positive electrode active material layer 40 may include a positive electrode active material, a solid electrolyte, a conductive additive, a binder, and the like.

The positive electrode active material may reversibly store and release lithium ions. The positive electrode active material may include an oxide active material or a sulfide active material.

The oxide active material may include a rock-salt-layer-type active material, such as LiCoO₂, LiMnO₂, LiNiO₂, LiVO₂, Li1_{30 x}Ni_{1/3}Co_{1/3}Mn_{1/3}O₂, etc., a spinel-type active material, such as LiMn₂O₄, Li(Ni_{0.51}Mn_{1.5})O₄, etc., an inversed-spinel-type active material, such as LiNiVO₄, LiCoVO₄, etc., an olivine-type active material, such as LiFePO₄, LiMnPO₄, LiCoPO₄, LiNiPO₄, etc., a silicon-containing active material, such as Li₂FeSiO₄, Li₂MnSiO₄, etc., a rock-salt-layer-type active material in which a part of transition metal is substituted with dissimilar metal, such as LiNi_{0.8}Co_{0.2-x)}AlₓO₂, a spinel-type active material in which a part of transition metal is substituted with dissimilar metal, such as Li₁₊ₓMn_{2-x-y}M_{y}O₄(M is at least one of Al, Mg, Co, Fe, Ni, and Zn, 0<x+y<2), and a lithium titanate, such as Li₄Ti₅O₁₂, and the like.

Examples of the sulfide active material may include a copper Chevrel, an iron sulfide, a cobalt sulfide, a nickel sulfide, and the like.

The solid electrolyte may include an oxide solid electrolyte or a sulfide solid electrolyte. However, preferably, a sulfide-based solid electrolyte having a high lithium ion conductivity may be used. The sulfide-based solid electrolyte is not particularly limited but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n is each independently a positive integer, and Z is one of Ge, Zn and Ga), Li₂S—GeS₂, Li₂S—SiS₂—Li₃PO₄, Li₂S—SiS₂—LiₓMO_{y} (where x and y is each a positive integer, and M is one of P, Si, Ge, B, Al, Ga, and In), Li₁₀GeP₂S₁₂, or the like.

The conductive additive may include carbon black, conducting graphite, ethylene black, graphene, or the like.

The binder may include butadiene rubber (BR), nitrile butadiene rubber (NBR), hydrogenated nitrile butadiene rubber (RNBR), polyvinylidene difluoride (PVDF), polytetrafluoroethylene (PTFE), carboxymethylcellulose (CMC), or the like.

The positive electrode current collector 50 may be an electrically conductive plate-shaped substrate. The positive electrode current collector 50 may include aluminum foil

FIG. 4 shows an exemplary method of manufacturing an all-solid-state battery, according to an exemplary embodiment of the present disclosure. As shown in FIG. 1 and FIG. 4, the manufacturing method may include steps of: preparing a laminate and charging the laminate, in which the laminate includes a negative electrode current collector 10, a precursor layer 60 positioned on the negative electrode current collector 10, a solid electrolyte layer 30 positioned on the precursor layer 60, a positive electrode active material layer 40 positioned on the solid electrolyte layer 30, and a positive electrode current collector positioned on the positive electrode active material layer 40. The precursor layer 60 includes a carbon component and a metal which can form an alloy with lithium. The laminate is charged to cause an alloying reaction between the metal and lithium so that an intermediate layer including a lithium alloy and the carbon component will be formed. The method of manufacturing each layer of the laminate is not particularly limited but the method may be a wet process or a dry process. For example, each layer of the laminate can be prepared by mixing raw materials of each layer in a powder state and then compressing the raw material mixture. Alternatively, each layer may be formed by preparing a slurry from a raw material powder and then applying and drying the slurry on a substrate.

The metal component may include one selected from the group consisting of Au, Pt, Pd, Si, Ag, Al, Bi, Sig, Zn, and combinations thereof.

When the precursor layer 60 is composed of a plurality of layers each including the carbon component and the metal component, an intermediate layer 20′ composed of a plurality of layers can be formed as illustrated in FIG. 3.

As shown in FIG. 4, when the laminate is charged, lithium ions released from the positive electrode active material layer 40 move to the precursor layer 60 through the solid electrolyte layer 30. The lithium ions undergo a lithiation reaction with the metal contained in the precursor layer 60 to form a lithium alloy.

In order to cause the lithiation reaction, the laminate may be charged at a temperature in a range of about 45° C. to 60° C. When the laminate is charged at a temperature less than about 45° C., a lithium alloy may not be formed.

In addition, the laminate may be charged at a voltage level of about 2.5 V to 4.25 V at a charging rate of about 0.1 C to 1 C to a state of charge (SoC) level of about 10% or less. Here, the term “SoC” refers to a state of being charged and may be expressed as a percentage by dividing the currently available charge by the total charge capacity of the battery. The SoC level can be measured by a voltage method and a current integration method. The voltage method may calculate the SoC level by measuring the battery voltage and comparing the measured voltage with a discharge curve. The current integration method may calculate the SoC level by measuring the battery current and performing a time integration of an electric current.

When the all-solid-state battery operates at room temperature later, the lithium ions forming the lithium alloy do not change back to the positive electrode active material but are present in the form of a lithium alloy. Accordingly, when the laminate is charged in a condition of an SoC level of above about 10%, the remaining amount of lithium ions in the positive electrode active material may decrease, so that the battery capacity may be reduced. In addition, to solve the above problem, the lithium alloy can be excessively injected, or a loading amount of the positive electrode active material may be increased. In particular, when the loading amount of the positive electrode active material is increased so that the capacity of a positive electrode becomes higher than the capacity of a negative electrode, the potential of the negative electrode does not reach the level at which lithium alloys are decomposed. Therefore, even though the capacity of the positive electrode is entirely expressed, the problem described above may be prevented.

### EXAMPLE

Another embodiment of the present disclosure will be described in more detail through the following examples. The following examples are only to help the understanding of the present disclosure, and the scope of the present disclosure is not limited thereto.

### Example 1

A laminate as illustrated in FIG. 4 was prepared. Particularly, a precursor layer including a carbon component and silver (Ag) was formed on a negative electrode current collector. A solid electrolyte layer including a sulfide-based solid electrolyte was formed on the precursor layer. A positive electrode active material layer including a nickel-cobalt-manganese structure as a positive electrode active material was formed on the solid electrolyte layer. A laminate was prepared by attaching a positive electrode current collector onto the positive electrode active material.

An intermediate layer was formed by charging the laminate at a voltage level of 2.5 V to 4.25 V at a charging rate of 0.33 C at a temperature of about 50° C. The intermediate layer, which is a monolayer, contained a lithium-silver alloy and had a thickness in a range of about 5 μm to 10 μm. An all-solid-state battery including the intermediate layer was designated Example 1.

### Example 2

A laminate was prepared in the same manner as in Example 1, except that a precursor layer was formed of two layers.

The laminate was charged under the same condition as in Example 1 to form a two-layer intermediate layer which had a thickness in a range of about 5 μm to 10 μm and contained a lithium-silver alloy. All of the layers constituting the intermediate layer were adjusted to have an equal thickness. An all-solid-state battery including the intermediate layer was designated Example 2.

### Comparative Example

A laminate prepared in Example 1 was designated Comparative Example.

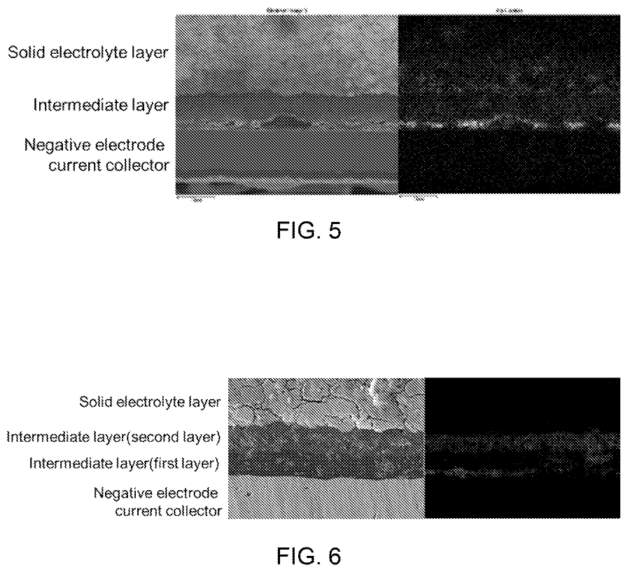

FIG. 5 shows results of analysis performed with a scanning electron microscope (SEM) and an energy dispersive X-ray spectrometer (EDS) for a cross-section of an all-solid-state battery according to Example 1.

FIG. 6 shows SEM and EDS analysis results for a cross section of an all-solid-state battery according to Example 2.

As shown in the result of EDS of FIG. 5, in the case of Example 1, many silver (Ag) atoms are present in a region near the negative electrode current collector in a direction of the thickness of the intermediate layer. That is, in Example 1, there is a content gradient in the intermediate layer due to the movement of lithium-silver alloy during the manufacturing process.

On the other hand, as shown in the EDS result of FIG. 6, in the case of Example 2, silver (Ag) atoms were uniformly distributed in the thickness direction of the intermediate layer. In Example 2, the movement of lithium-silver alloy was suppressed by an interlayer barrier, and thus the lithium-silver alloy was evenly present along in the thickness direction of the intermediate layer.

All-solid-state batteries according to Example 1, Example 2, and Comparative Example were charged to an SoC level of 100% at a temperature about 25° C.

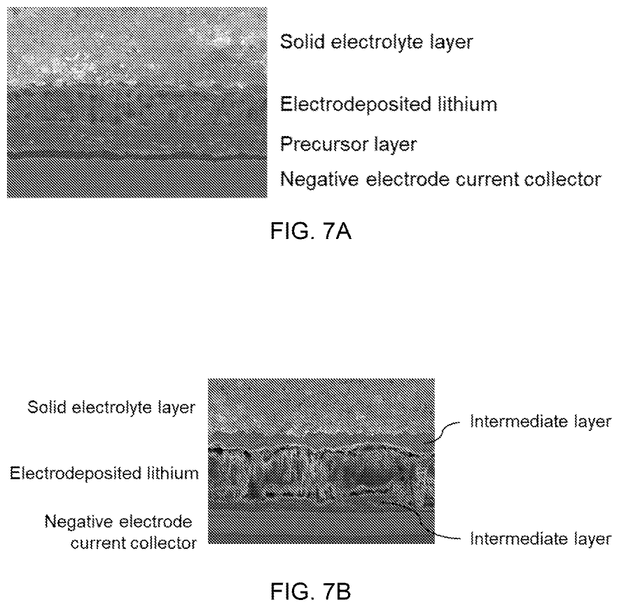

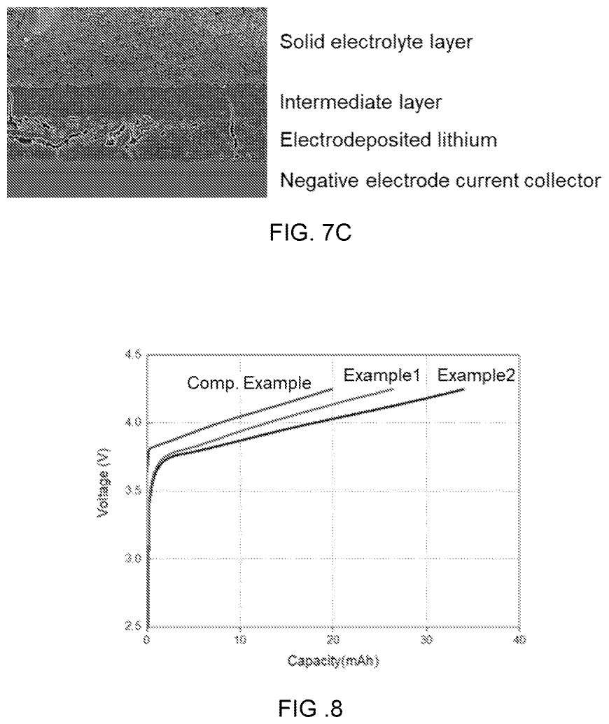

FIG. 7A shows a result of analysis performed with a cross-section polisher-scanning electron microscope (CP-SEM) for a cross section of an all-solid-state battery according to Comparative Example, the analysis being performed after charging the all-solid-state battery. As shown in FIG. 7A, in the case of Comparative Example, lithium ions were not allowed to pass through the precursor layer and were electrodeposited between the solid electrolyte layer and the intermediate layer, because lithium ions failed to perform a lithiation reaction with silver (Ag) included in the precursor layer during the room-temperature charging. When lithium ions are electrodeposited between the solid electrolyte layer and the intermediate layer, lithium dendrites may grow, which may cause short-circuiting in the battery.

FIG. 7B shows a CP-SEM analysis result for a cross-section of an all-solid-state battery according to Example 1, the analysis being performed after charging the all-solid-state battery. As shown in FIG. 7B, in the case of Example 1, lithium ions moved to the intermediate layer and were electrodeposited therein. From the analysis result of Example 1 that the all-solid-state battery can be reversibly charged and discharged with lithium dendrites being suppressed at room temperature.

FIG. 7C shows a CP-SEM analysis result for a cross-section of an all-solid-state battery according to Example 2, the analysis being performed after charging the all-solid-state battery. As shown in FIG. 7C, in the case of Example 2, lithium ions were highly densely electrodeposited between the intermediate layer and the negative electrode current collector. This is because lithium ions easily moved in the intermediate layer due to the uniform distribution of the lithium alloy in the intermediate layer.

FIG. 8 shows the results of measuring the capacity of each of the all-solid-state batteries according to Example 1, Example 2, and Comparative Example. The capacity was measured by charging and discharging each of the all-solid-state batteries at a temperature of about 25° C. at a voltage level of 2.5 V to 4.25 V. As shown in FIG. 8, the batteries of Example 1 and Example 2 exhibited greater charging capacity and lower resistance than the battery of Comparative Example, because the batteries of Examples 1 and 2 had greater lithium ion conductivity and better electrodeposition properties than the battery of Comparative Example.

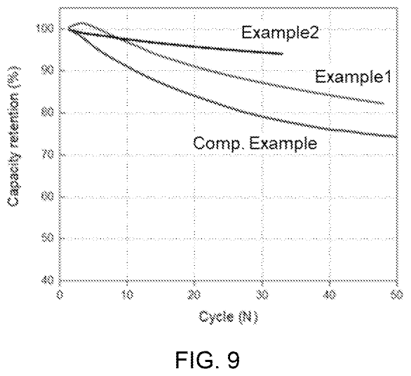

FIG. 9 shows the results of evaluating the durability of each of the all-solid-state batteries according to Example 1, Example 2, and Comparative Example. The capacity retention rate for each cycle was measured while charging and discharging each of the all-solid-state batteries at a temperature of about 25° C. at a voltage level of 2.5 V to 4.25 V. As shown in FIG. 9, the batteries of Examples 1 and 2 show a greater capacity retention rate than the battery of Comparative Example, because in the case of Examples 1 and 2, lithium was uniformly electrodeposited. In particular, the battery of Example 2 exhibited a capacity retention rate of about 95% at 30 cycles of charging and discharging. As shown in FIG. 7C, this is because lithium was highly densely electrodeposited between the intermediate layer and the negative electrode current collector, and thus lithium reversibility was high in the case of Example 2.

While the present disclosure has been particularly shown and described with reference to various exemplary embodiments thereof, it is to be understood that the scope of the present disclosure is not limited to the disclosed exemplary embodiments. Modified forms are also included within the scope of the present disclosure

What is claimed is:

1. An all-solid-state battery comprising:
a negative electrode current collector;
an intermediate layer disposed on the negative electrode current collector;
a solid electrolyte layer disposed on the intermediate layer;
a positive electrode active material layer disposed on the solid electrolyte layer and comprising a positive electrode active material lithiating and delithiating lithium ions; and
a positive electrode current collector disposed on the positive electrode active material layer,
wherein the intermediate layer comprises a carbon component and a lithium alloy.

2. The all-solid-state battery of claim 1, wherein the lithium alloy comprises lithium and one or more metal selected from the group consisting of Au, Pt, Pd, Si, Ag, Al, Bi, Sn, and Zn.

3. The all-solid-state battery of claim 1, wherein the lithium alloy has a particle size (D50) of about 50 nm or less.

4. The all-solid-state battery of claim 1, wherein the intermediate layer comprises the lithium alloy in a discharged state of the all-solid-state battery.

5. The all-solid-state battery if claim 1, wherein the intermediate layer comprises an amount of about 30% to 85% by weight of the carbon component and an amount of about 15% to 70% by weight of the lithium alloy based on the total weight of the intermediate layer.

6. The all-solid-state battery of claim 1, wherein the intermediate layer comprises a plurality of layers each of which layers comprises the carbon component and the lithium alloy.

7. The all-solid-state battery of claim 6, wherein an interlayer barrier is disposed on the each of the plurality layer of the intermediate layer for allowing lithium ions to pass through but not allowing the lithium alloy to pass through.

8. The all-solid-state battery of claim 1, wherein the intermediate layer has a thickness in a range of about 3 μm to 30 μm.

9. The all-solid-state battery claim 1, wherein the battery has an operating temperature of about 40° C. or less.

10. A method of manufacturing an all-solid-state battery, comprising:
preparing a laminate comprising a negative electrode current collector, a precursor layer disposed on the negative electrode current collector, a solid electrolyte layer disposed on the precursor layer, a positive electrode active material layer disposed on the solid electrolyte layer, and a positive electrode current collector disposed on the positive electrode active material layer, wherein the precursor layer comprises a carbon component and a metal component capable of forming an alloy with lithium, and the positive electrode active material layer comprises a positive electrode active material lithiating and delithiating lithium ions; and
charging the laminate to initiate an alloying reaction between the metal component and lithium, thereby forming an intermediate layer comprising a lithium alloy and the carbon component.

11. The method of claim 10, wherein the metal component comprises one or more selected from the group consisting of Au, Pt, Pd, Si, Ag, Al, Bi, Sn, and Zn.

12. The method of claim 10, wherein the laminate is charged at a temperature in a range of about 45° C. to 60° C.

13. The method of claim 10, wherein the laminate is charged at a voltage level of about 2.5 V to 4.25 V at a charging rate of about 0.1 C to 1 C to an SoC level of about 10% or less so that the alloying reaction occurs between the metal and lithium.

14. The method of claim 10, wherein the lithium alloy has a particle size (D50) of about 50 nm or less.

15. The method of claim 10, wherein the intermediate layer comprises the lithium alloy in a discharged state of the all-solid-state battery.

16. The method of claim 10, wherein the intermediate layer comprises an amount of about 30% to 85% by weight of the carbon component and an amount of about 15% to 70% by weight of the lithium alloy, based on the total weight of the intermediate layer.

17. The method of claim 10, wherein the precursor layer comprises a plurality of layers each of which comprises the carbon component and the metal component, thereby forming the intermediate layer with the plurality of layers each comprising the carbon component and the lithium alloy.

18. The method of claim 17, wherein an interlayer barrier is disposed on the each of the plurality layer of the intermediate layer for allowing lithium ions to pass through but not allowing the lithium alloy to pass through.

19. The method of claim 10, wherein the intermediate layer has a thickness in a range of about 3μm to 30 μm.

20. The method of claim 10, wherein the battery has an operating temperature of about 40° C. or less.
